(19) United States
(12) Patent Application Publication
(10) Pub. No.: US 2003/0163365 A1
(43) Pub. Date: Aug. 28, 2003

(54) Total customer experience solution toolset

(76) Inventors: Christopher Dean Farnes, Spokane, WA (US); Amy Silverman, Vancouver, WA (US); Stephen Paul Bear, Bristol (GB); David J. Wong, Boise, ID (US); Suzanne Jonas, San Ramon, CA (US)

Correspondence Address: HEWLETT-PACKARD COMPANY, Intellectual Property Administration, P.O. Box 272400, Fort Collins, CO, 80527-2400, US

(21) Appl. No.: 10/085,652

(22) Filed: Feb. 27, 2002

(51) Int. Cl. G06F 17/60

(52) U.S. Cl. 705/11

(57) ABSTRACT

A method for developing a solution to a customer experience issue. In one embodiment, the method includes: identifying a target customer including customer requirements and a customer profile; defining a current customer experience and comparing it with a customer experience provided by a competitor; summarizing values and benefits that should be provided to the target customer; identifying metrics for measuring success of a solution; identifying gaps between current solutions and the benefits; and generating solutions for delivering the benefits and selecting a solution path which delivers the greatest number of benefits.

### TECHNICAL FIELD

The present invention relates to a method and system for developing a solution to a customer experience issue. More specifically, the present invention pertains to a method and system which provide a set of actions and tools to help identify and model customer experience requirements.

### BACKGROUND ART

Interactions between businesses and their customers are often thought of as the direct interaction between a business employee or representative and a customer, perhaps over the telephone or face-to-face across a store counter, for example. However, interactions between businesses and customers can occur in a variety of other ways as well. When a customer uses a product or service offered by a business, this represents a type of interaction. Customer interaction with the business's Web site represents another type of interaction.

Each interaction can be generally characterized as a positive or negative customer experience. Clearly, it is in a business's best interest to provide positive customer experiences, and to strive for improvement even when positive customer experiences are realized.

Once a business identifies a customer experience issue as a candidate for improvement, the business will typically assign to an individual or team the task of developing solutions to the issue. A problem occurs when, for any of a variety of reasons, it is necessary to assign this task to individuals not experienced with solving customer experience issues.

One solution to this problem is to increase the level of training of employees as well as the number of employees trained, to create a pool of knowledgeable people trained to address customer experience issues. While this may be ideal, it is often not economically feasible because training can be expensive. Training also diverts people from their normal duties, and often additional training is needed to keep people up to date. Furthermore, training introduces problems with identifying the right number of employees to train and with making sure that the right mix of employees is trained. Thus, training may not be the most practical solution.

Accordingly, what is needed is a method and/or system that can be used by teams, even inexperienced ones, to identify solutions to customer experience issues. The present invention provides a novel solution to this need.

### DISCLOSURE OF THE INVENTION

The present invention provides a method that can be used by teams, even inexperienced ones, to identify solutions to customer experience issues.

Embodiments of the present invention pertain to a method for developing a solution to a customer experience issue. In one embodiment, the method includes: identifying a target customer including customer requirements and a customer profile; defining a current customer experience and comparing it with a customer experience provided by a competitor; summarizing values and benefits that should be provided to the target customer; identifying metrics for measuring success of a solution; identifying gaps between current solutions and the benefits; and generating solutions for delivering the benefits and selecting a solution path which delivers the greatest number of benefits.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a flowchart of a method for developing a solution to a customer experience issue in accordance with one embodiment of the present invention.

FIGS. 2A, 2B and 2C further illustrate a method for developing a solution to a customer experience issue in accordance with one embodiment of the present invention.

### BEST MODE FOR CARRYING OUT THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. In other instances, well-known methods, procedures, components, and circuits have not been described in detail so as not to unnecessarily obscure aspects of the present invention.

Embodiments of the present invention pertain to a set of prescribed set of actions and tools to help a person (or team of people) to identify customer needs and to define a solution path and architecture that meet customer requirements and that are aligned with business objectives. For simplicity of discussion, the present invention is referred to herein as the Total Customer Experience (TCE) Solution Toolset or TCE solution toolset.

In one embodiment, the method of the present invention is implemented as a computer-based set of instructions that guide the user through the overall process in a step-by-step fashion. Directions are explicit, and in one embodiment, templates, examples and job aids are provided to illustrate the correct way to complete each task. As such, the TCE solution toolset is designed for users having a wide range of experience levels, including those with no prior experience.

The TCE solution toolset is intended to help develop an understanding of customers and their customer experience requirements, including an understanding of customer experience requirements relative to the competition. Outputs of the process include target customer and environmental profiles, a current customer experience flow, a future customer experience flow, a competitive profile, a customer benefit roadmap, a solution path definition, vision scenarios, a high-level solution architecture, a value delivery system model, pre-release and post-release success criteria and metrics, and a project risk assessment.

In summary, the present invention provides an approach that utilizes preceding work and systematically leads the user to identify and develop an appropriate solution to a customer experience issue. The TCE solution toolset introduces common processes and deliverables that can be shared across multiple organizations within a business.

Aspects of the present invention may be practiced on a computer system that includes, in general, a processor for processing information and instructions, random access (volatile) memory (RAM) for storing information and instructions, read-only (non-volatile) memory (ROM) for storing static information and instructions, a data storage device such as a magnetic or optical disk and disk drive for storing information and instructions, an optional user output device such as a display device (e.g., a monitor) for displaying information to the computer user, an optional user input device including alphanumeric and function keys (e.g., a keyboard) for communicating information and command selections to the processor, and an optional user input device such as a cursor control device (e.g., a mouse) for communicating user input information and command selections to the processor. The computer system may also include an input/output device for providing a physical communication link between the computer system and a network, using either a wired or a wireless communication interface.

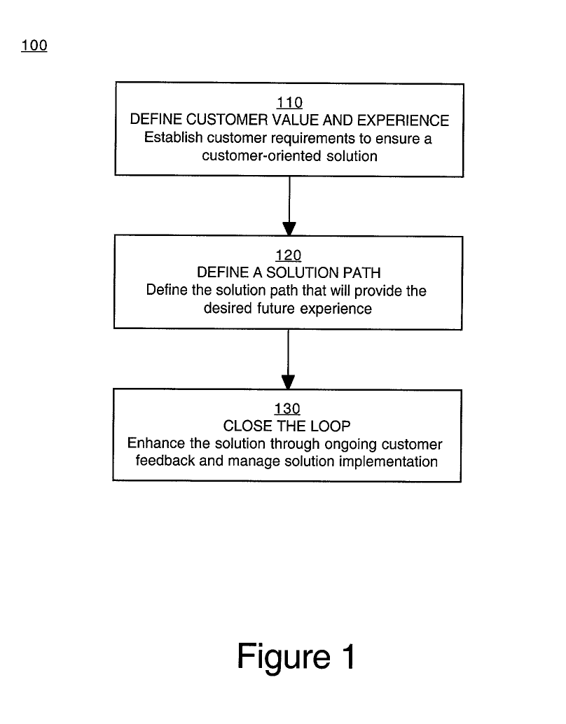

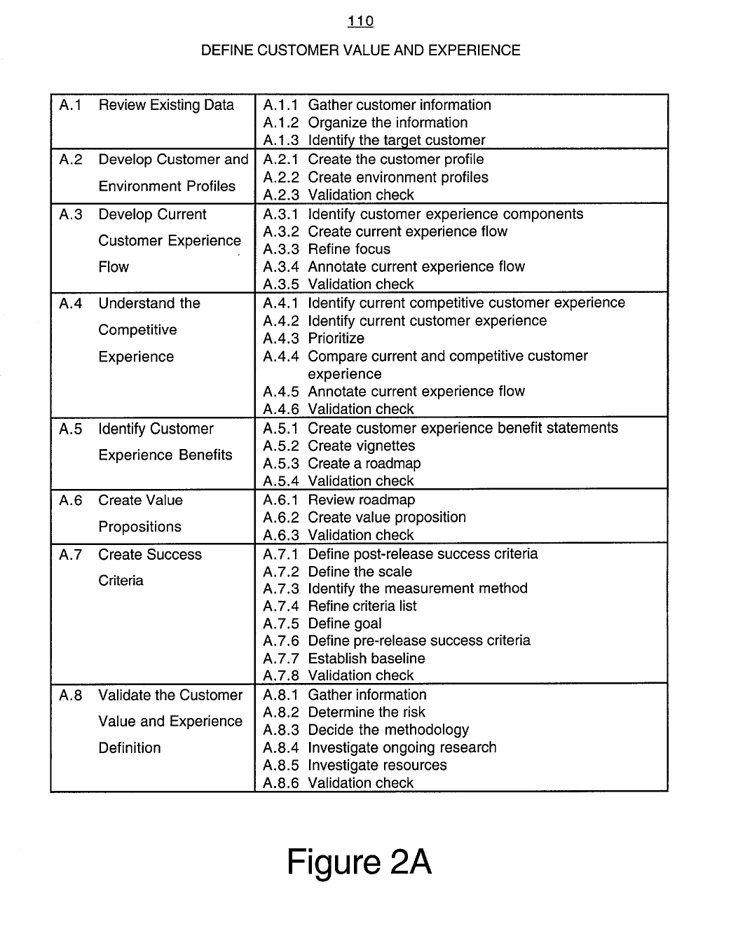

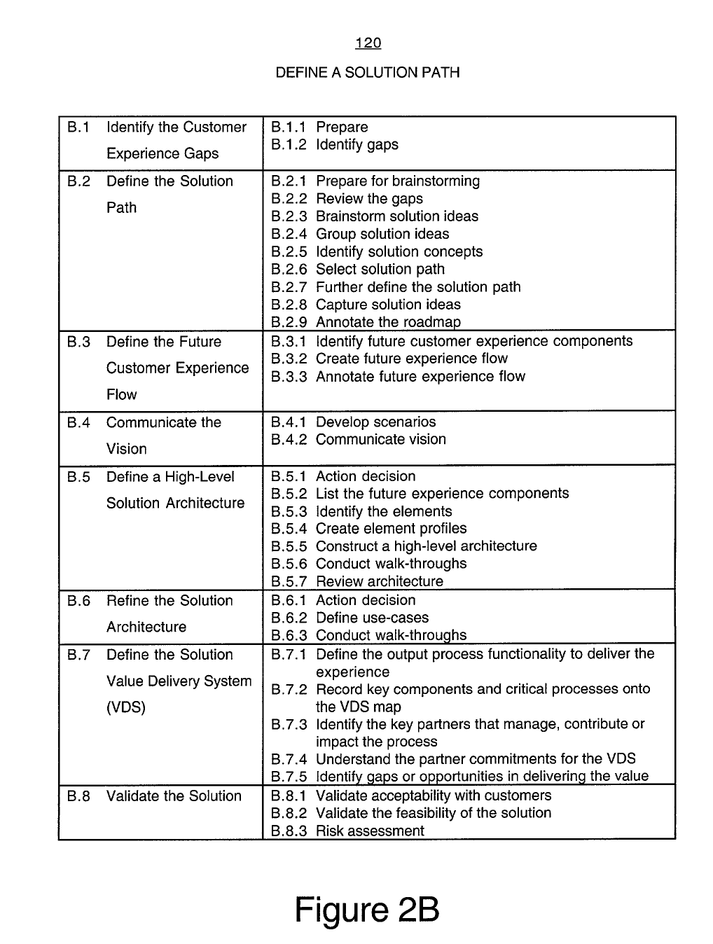

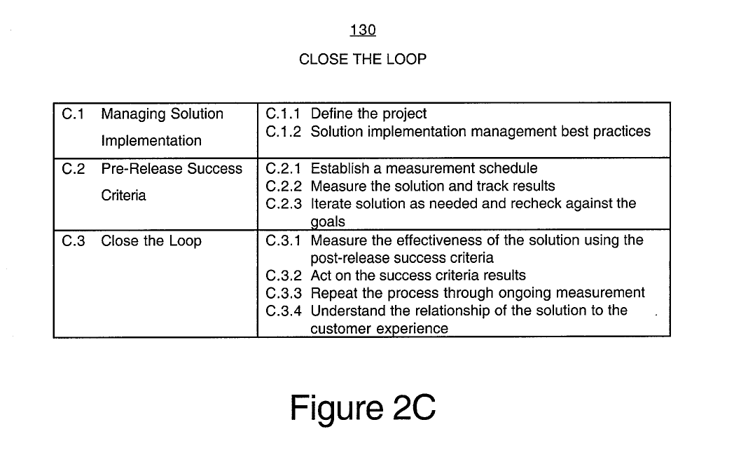

FIG. 1 is a flowchart of a method 100 for developing a solution to a customer experience issue in accordance with one embodiment of the present invention. A user at one computer system can access this tool from another computer system in a network. As a software tool, the present invention may provide the user with a series of Web pages, the content of which provides explicit directions for implementing the method as well as links (hyperlinks) to other resources. These other resources may include a glossary of terms, templates, examples, and access to other Web sites and references that provide yet more resources. These features are described in more detail in conjunction with FIGS. 2A, 2B and 2C, below.

In step 110 of FIG. 1, according to the present embodiment of the present invention, customer value and customer experience are defined in order to establish a foundation in customer requirements to ensure a customer-centered solution. The actual needs and priorities of the customer are balanced with business objectives. Inputs to this phase of the TCE solution toolset include identification of the customer experience focus, relevant competitors, relevant benchmarking information, identification of the actual needs and priorities of the customer, and business objectives. The customer experience focus identifies the customer experience issue to be resolved. Benchmarking information can include data (metrics) showing current customer satisfaction levels. These data are used to set predictive and target metrics (success criteria) for the improved customer experience.

Participants in this phase include those people who are knowledgeable about the customers affected by the customer experience focus. Other participants can include a cross-functional team of individuals with insights into customer requirements and key benefits, such as people from sales, a call (service) center, marketing, customer satisfaction and service, and human factors.

The objectives of this phase include achieving an understanding of who the customer is, what their current customer experiences are like, how their experiences compare to experiences with competitors, what the desired experience is, and how this desired experience can be achieved (evolved) over time. Outputs (e.g., deliverables) from this phase include target customer and environmental profiles, the current customer experience flow, a competitive gap analysis, a prioritized list of customer experience benefits, a roadmap populated with the highest priority customer benefits, a detailed vignette describing customer requirements delivered with the benefits, a value proposition outlining what value should be offered and to whom, and a set of success criteria for each milestone on the roadmap.

Completion of step 110 creates a customer-centered foundation before moving forward with identifying solutions. By completing this phase, solutions developed later are more likely to match the highest priority desires of the customer. Additional information regarding step 110 is provided in conjunction with FIG. 2A, below.

In step 120 of FIG. 1, in the present embodiment, a solution path is defined that will provide the desired future customer experience. Inputs to this phase include identification of the target customers, the specific customer experience that needs to be improved and why, the specific customer benefits required to improve the customer experience, and the business objectives and constraints.

Participants in this phase can include those people with insights into the target customers and their requirements, business objectives and plans, the current solution being provided, and the current “value delivery system” (e.g., the internal and external organizations and individuals who are involved in providing the current solution).

The objectives of this phase include the definition of a solution path and architecture needed to achieve the future customer experience requirements that are specified in step 110. These requirements are mapped to the customer benefits roadmap along with the future customer experience flow and value delivery system requirements, and are used to define the solution path and architecture that will best achieve the established goals.

Outputs of this phase include identification of current customer experience gaps, a solution selection matrix, a solution path selection matrix, a customer benefit roadmap, a future customer experience flow diagram, solution scenarios, solution architecture element profiles, a high-level solution architecture, “use-cases” defining the specific interactions that the architecture will need to support, a detailed solution architecture, and a value delivery system map. Additional information regarding step 120 is provided in conjunction with FIG. 2B, below.

In step 130 of FIG. 1, implementation of the solution is managed and the solution is enhanced through ongoing customer feedback. Inputs to this phase include a high-level solution architecture that has been refined by applying the use-cases, solution scenarios used to refine the vision of the future customer experience, and a definition of the future value delivery system.

Participants in this phase can include those people who understand the customers affected by the customer experience issue, people with insight into project management, people who have a stake in implementing the solution and resolving the original customer experience issue or focus, solution development teams, and the organizations and individuals identified as being in the value delivery system.

The objectives of this phase include closing the loop with customers to determine whether the original customer experience issue or focus has been resolved. This can be accomplished by soliciting customer feedback both before and after release of a solution, as well as at each solution milestone.

Outputs of this phase include identification of the objectives and scope of the project or projects required to implement a selected solution; an understanding of the importance of establishing a schedule, the resource commitments and a communication plan; identification of mechanisms for measuring and tracking pre-release and post-release success criteria; an understanding of how to act on results by making changes to the solution to increase the effectiveness of the solution; and an understanding of the importance of continued receipt of customer feedback. Additional information regarding step 130 is provided in conjunction with FIG. 2C.

FIGS. 2A, 2B and 2C further illustrate the method 100 for developing a solution to a customer experience issue in accordance with one embodiment of the present invention. It is appreciated that the method described by FIGS. 2A, 2B and 2C can be performed in an order different from that described.

In accordance with the present invention, for each step, the set of prerequisites (inputs) are defined as well as the expected outputs (deliverables). Also, when appropriate or available, links are provided to other sources of information (e.g., Web sites or job aids) that assist the user in completing a step. Furthermore, templates are provided when necessary or appropriate; these templates aid the user by defining the type and format of information needed to complete a step. Links to the templates are provided, or the templates can be accessed using their file names.

To further assist the user, an example illustrating the application of the process to a representative case is provided. For the representative case, the process of the present invention is applied to generate example inputs and outputs for each step, such as completed templates and the like. The example can be accessed by the user at any point in the process. The user thus has an example to refer to for guidance on how to complete a step, and/or on whether that step is necessary for them to complete or has already been completed.

With reference first to FIG. 2A, in the present embodiment, step 110 includes steps A.1 through A.8. In step A.1, relevant existing customer, competitor and business data are reviewed with the ultimate aim of identifying the needs of the target customer(s), the relationship of the target customer(s) to the entire body of customers, the current customer experience flow, and the opportunities for improvement. Identification of the target customer allows the needs of the relevant customer segment to be separated from those of the other customer segments.

Inputs to step A.1 include the relevant customer requirements and needs, relevant competitor information, the business objectives relevant to the customer focus or issue, and existing customer segmentation models. Outputs of step A.1 include documentation of the customer and competitor information and of the business objectives.

Continuing with reference to FIG. 2A, in step A.1.1 of step A.1 in the present embodiment, data about the customer that is affected by the customer issue or focus are collected considering a variety of sources including: existing segmentation models or market research, qualitative market research, industry-published customer research, call center data, customer visit research, competitive analysis data, customer satisfaction information, relevant business objectives, and the like.

In step A.1.2 of step A.1, in the present embodiment, the collected information is organized and a determination is made regarding whether enough information has been gathered to allow the process to proceed with confidence that the target customers and their requirements are adequately understood. The information is organized according to who the target customers are, how their needs are currently being met, what are their expectations, in what kind of environments do the customers deal with the customer issue or focus (e.g. the physical, business, political, and/or cultural environment), who the competition is, and what the current business situation is.

In step A.1.3 of the present embodiment, the target customers are identified. The target customers represent the key customer segment affected by the customer experience issue. In some cases, a known customer segmentation model can be used. When such a model is not available, the target customers can be identified using a known affinity process. In the present embodiment, a link is provided to a reference Web site that provides information describing an affinity process. Also, access is provided to a template for the affinity process.

In step A.2 of FIG. 2A, customer and/or environment profiles of attributes and values relevant to the customer experience issue are created. Inputs to step A.2 include the target customer experience focus, and the customer requirements data and target customer identity generated in step A.1.

In step A.2.1, in the present embodiment, the customer profile of the target customer is created. Job aids and templates are provided to assist the user in creating the customer profile. The job aids can be used to determine those attributes which best capture items that are both important to the target customer and aligned with the customer experience focus. A customer profile template can be used to summarize the key attributes, the sources of information used, and the degree of confidence in that information.

In step A.2.2 of the present embodiment, environmental profiles are created. Job aids are again provided to assist the user. The job aids can be used to determine those attributes which best capture those items about the customer environment that may act as constraints to the customer experience. An environmental profile template can be used to summarize the key attributes, the sources of information used, and the degree of confidence in that information. All environment types can be considered, including the physical, business, political and cultural environments, and it may be desirable to complete an environmental profile for each type of environment.

In step A.2.3, in the present embodiment, a validation check is performed to assess confidence in the customer and environmental profiles. As part of the validation check, the profiles may be validated with actual customers. The validation check is described further in conjunction with step A.8, below.

In step A.3 of FIG. 2A, a current customer experience flow for the target customer is generated. The customer experience flow includes the process components, elements or steps involved in the current customer experience. In the present embodiment, the customer experience flow is represented using a flow diagram; a job aid is provided to assist the user in this task. Inputs to step A.3 include the target customer experience focus and metrics, the customer requirements data from step A.1, and the customer and environmental profiles from step A.2.

In step A.3.1, in the present embodiment, customer experience components that articulate the use of the current solution are identified. These components are relative to the current customer experience focus, and are generally about the customers and their experiences relative to the current solution.

In step A.3.2, in the present embodiment, a flow diagram is created that represents the order of the customer experience components and their sequential relationship. The customer experience flow represents the fundamental experience for the target customers that is to be redesigned as part of the solution to the customer experience issue.

In step A.3.3 of the present embodiment, the current customer experience flow can be refined as necessary if, for example, the flow is overly complex or represents several activities related to the customer experience focus. The scope of the customer experience flow can be refined bearing in mind the objective that the scope needs to deliver to the metrics.

In step A.3.4, in the present embodiment, the current customer experience flow is annotated to include unmet needs and dissatisfiers as well as customer experience requirements. That is, near each component in the flow diagram, comments are made to relate unmet needs and customer experience requirements to the associated component.

In step A.3.5, in the present embodiment, a validation check is performed per step A.8 to assess confidence in the adequacy of the current customer experience flow diagram.

In step A.4 of FIG. 2A, the competitive experience relative to the customer experience focus is analyzed. Inputs to step A.4 include the competitive data and other customer experience data collected in step A.1, and the current customer experience flow generated in step A.3. Outputs of step A.4 include a documented competitive experience profile. If there are no competitors, then step A.4 can be skipped.

In step A.4.1 of the present embodiment, competitors are identified, in particular those competitors considered best in class and identified by customers as providing a superior customer experience relative to the current solution. Data, including data reflecting both actual and perceived experiences, are gathered and documented for the competitive customer experience. A template can be used to assist the user in this task.

In step A.4.2, in the present embodiment, data about the current customer experience (actual and perceived) that led to the identification of the current customer experience focus are gathered and documented.

In step A.4.3 of the present embodiment, attributes of the current customer experience and of the competitive customer experience are prioritized according to their impact on the customer experience.

In step A.4.4 of the present embodiment, the prioritized lists generated in step A.4.3 are compared so that gaps between the current solution and the competition can be identified. These gaps can be documented in the competitive experience profile generated in step A.4.1.

In step A.4.5, in the present embodiment, the current experience flow diagram (from step A.3) is annotated to associate the competitive gaps with the relevant components in the diagram.

In step A.4.6 of the present embodiment, a validation check per step A.8 is performed to assess confidence that the competitor's customers and their environment are accurately reflected.

In step A.5 of FIG. 2A, customer experience benefits are identified. Inputs to step A.5 include the customer and environmental profiles from step A.2, the annotated current customer experience flow from step A.3, and the competitive experience profile from step A.4.

In step A.5.1, in the present embodiment, a list of benefits is generated using a technique such as brainstorming. Benefit statements are created from customer research and competitive analyses. The benefit statements are intended to be about the value that the target customers desire from the solution to the customer experience issue.

Once the benefits are identified, they can be combined or deleted to remove redundant items from the list. The benefits can then be organized using a known process such as the Kano Model. A template can be used to assist the user in this task. Also, a link is provided to other resources to assist the user in understanding and applying the Kano Model. As a result of applying the Kano Model, benefits are categorized as being an “ante” (a benefit that is required), a “baseline” (a benefit that increases customer satisfaction as value is increased), and a “delighter” (a benefit that only delivers value if the benefit is present but that does not decrease value if not present).

After the benefits are categorized, they can be prioritized within each category. A template can be used to assist the user.

The benefits are next aligned with the business objectives, and ranked according to their contribution to accomplishing the objective. Benefits may be considered as required to accomplish a business objective, important to accomplishing a business objective, not applicable to a business objective, or a hindrance to accomplishing a business objective.

In step A.5.2 of the present embodiment, a customer requirements vignette is created for each of the selected benefits (benefits of high value to both customers and the business). A vignette is, in essence, a relatively brief summary articulating the benefit in terms of the customer experience.

In step A.5.3 of the present embodiment, a number of milestones is specified, each milestone representing a distinct grouping of customer values. For example, three milestones representing short, medium and long-term points in time can be specified. Using a template, a customer benefits roadmap can be created. The roadmap can include benefits, groups of benefits, and/or vignettes as well as the milestones. The roadmap can be used to determine relationships between benefits; for example, whether one benefit provides a foundation for another benefit. The roadmap can be revised to achieve a delivery strategy that provides customer value at each milestone.

Benefits having the highest value can then be selected. The selected benefits are then reviewed to ensure that there is adequate coverage of the ante and baseline benefits. For example, it may be desirable to deliver all of the ante benefits, or to at least deliver no less than the antes being delivered by competitors.

In step A.5.4, a validation check is performed per step A.8 to assess whether the benefits are what the customer wants, and whether the prioritization of benefits adequately matches customer expectations.

In step A.6 of FIG. 2A, for each milestone, a value proposition is created. A value proposition summarizes the value brought to the customer at the milestone, relative to the competition. Inputs to step A.6 include the customer and environmental profiles from step A.2, the current customer experience flow from step A.3, the competitive experience profile from step A.4, and the customer requirement vignettes from step A.5.

In step A.6.1, in the present embodiment, the benefits that are mapped on the aforementioned inputs are reviewed. In step A.6.2, the value propositions are created for each milestone. A template can be used to assist the user in performing this task. In step A.6.3, a validation check per step A.8 is performed to assess the value propositions.

In step A.7 of FIG. 2A, success criteria are created. The success criteria are quantitative measures that can be used to track progress and determine whether a solution is ready for release, as well to evaluate whether the solution achieves what it is supposed to. Success criteria are created for each milestone and value proposition on the customer benefit roadmap. According to the present embodiment, two types of measures are used for the success criteria: pre-release success criteria measures, and post-release success criteria measures. The pre-release criteria measure the evolution towards the value propositions, and allow changes to be made to the solution before it is released. The post-release criteria are used to determine the success of meeting the value propositions and can be used to make changes to the solution at the next solution release.

Inputs to step A.7 include the customer requirements data from step A.1, the competitive experience information from step A.4, and the customer benefit roadmap and value propositions from step A.6.

In step A.7.1, in the present embodiment, the post-release success criteria are defined for each milestone and value proposition. The criteria are defined such that accomplishment of the success criteria represents delivery of the value proposition for each milestone. The success criteria can then be recorded; a success criteria template is provided to assist the user in this task.

In step A.7.2, in the present embodiment, the unit of measure for the success criteria are specified. For example, a five point scale may be used. Other common measures may be based on a percentage of customers, the number of errors, performance items like time or number of steps, ratings of customer perception, conformance to standards, etc.

In step A.7.3, in the present embodiment, the measurement method is identified. For example, customer surveys, usability testing, service call logs, etc., may be used.

In step A.7.4, in the present embodiment, the criteria are refined with regard to their number, feasibility and other factors that might influence the ability to measure and to make changes based on the measurement results.

In step A.7.5, in the present embodiment, a goal prescribing a range of acceptable results is defined. For example, maximum and minimum values for each success criterion can be established based on the customer requirements data.

In step A.7.6, in the present embodiment, the steps described above (steps A.7.1 through A.7.5) are repeated to define pre-release success criteria. The pre-release success criteria can be used to measure the likelihood of success throughout the process of developing a solution. The success criteria template completed above (step A.7.1) can be used to review and assess the post-release success criteria.

In step A.7.7 of the present embodiment, a baseline is established by measuring the success criteria against the current solution, the value propositions, or the competitive solution. The baseline can be used to determine the best goal for each measure.

In step A.7.8 of the present embodiment, a validation check per step A.8 is performed to assess the success criteria against those of the customer.

In step A.8 of FIG. 2A, the customer value and customer experience definitions generated in steps A.1 through A.7 are validated. In step A.8.1, in the present embodiment, the information to be validated is gathered.

In step A.8.2, in the present embodiment, a risk assessment is performed to determine the impact to the business and to the customers of moving forward with the information being used. For example, if the customer, environmental, and competitive profiles are based on customer information, the risk can be considered low. In general, the risk is assessed based on the degree of confidence in the accuracy of the information. The level of risk is used to determine which validation methodology and resources will be needed.

In step A.8.3 of the present embodiment, the methodology that will be used to validate the solution is selected. A job aid is provided to assist the user in comparing methodologies. In step A.8.4, customer data collection methodologies currently being used or planned for use with the target customer are determined and investigated. In step A.8.5, validation resources (e.g., customer focus groups, customer visits or interviews) are identified and investigated.

In step A.8.6, in the present embodiment, the validation is performed according to the selected methodology and resources. Customer information can then be updated as needed. Also, solution ideas offered by customers during the validation step can be documented and later considered.

Reference is now made to FIG. 2B, which describes step 120 in further detail. In the present embodiment, step 120 includes steps B.1 through B.8. At the end of each of the steps B.1 through 8.7, a validation check per step B.8 can be performed.

In step B.1 of FIG. 2B, the customer experience gaps are reviewed. The purpose is to determine whether the target customers are satisfied with the way the benefits are currently being delivered and, if not, the reason why. The inputs to step B.1 include the current experience flow diagram from step A.3, the customer benefit roadmap and the customer requirements vignettes from step A.5, and the value propositions from step A.6.

In step B.1.1, in the present embodiment, individuals are gathered that can provide insights with regard to the current solution, the current customer experience, and/or the future customer experience requirements.

In step B.1.2 of the present embodiment, for each benefit listed on the customer benefit roadmap, a determination is made with regard to whether the target customers are satisfied with the delivery of the benefit. If not, the aspect of the current solution that prevents it from delivering the benefit satisfactorily is identified. The information identifying the shortcomings of the current solution can be added to the current experience flow diagram; the diagram is annotated so that the description of the shortcoming is placed near the point in the flow diagram where the shortcoming occurs.

In step B.2 of FIG. 2B, a solution path that will achieve the desired future customer experience is identified and selected. Inputs to this step include the current experience flow diagram updated in step B.1, the customer benefit roadmap from step A.6, the success criteria from step A.7, and the solution ideas obtained from the customer validation of step A.8. Other inputs include the relevant business objectives, financial goals and constraints, and technology opportunities and constraints.

In step B.2.1, in the present embodiment, individuals are gathered that can provide insights into the shortcomings of the current customer experience, the competitive experience, the future customer experience requirements, the relevant business and financial objectives, and the technology opportunities and constraints.

In step B.2.2, in the present embodiment, the gaps (shortcomings) identified in the current customer experience flow diagram are reviewed. In step B.2.3, using a technique such as brainstorming, solution ideas are generated for each milestone in the customer benefit roadmap.

In step B.2.4, in the present embodiment, solution ideas are grouped to identify the different potential solution concepts that can be used to address the benefits. In step B.2.5, the solution concepts are mapped against the benefits to ensure that all of the benefits have been addressed by at least one solution concept. A template can be used to create a solution selection matrix to assist in the completion of this task. If there is a benefit not addressed by a solution concept, additional solution ideas can be generated to correct this.

In step B.2.6, in the present embodiment, the solution concept or concepts best suited to addressing the customer experience issue is identified. First, the solution selection matrix is reviewed to identify the solution concept or concepts that address all of the customer experience benefits. Each solution path so identified can then be evaluated to determine the best alternative using criteria such as the following: coverage of all benefits, alignment with value propositions and success criteria, alignment with business and financial objectives, alignment with technology objectives, and implementation viability. The object here is to identify the solution path that best meets these criteria. The solution path that will be advanced is selected and named. A solution path selection job aid provides a ranking technique to assist in the selection of a solution path.

In step B.2.7, in the present embodiment, the selected solution concepts included in each solution path are reviewed and refined considering factors such as systems, processes, objects and functions. The primary elements of the solution path and links between the elements are identified.

In step B.2.8 of the present embodiment, the solution concepts and paths, including those not selected, are documented for future use. In step B.2.9, a description of the selected solution path is added to the customer benefit roadmap, to communicate how the solution addresses the value propositions and customer experience benefits across the roadmap.

In step B.3 of FIG. 2B, the future customer experience flow is defined. Inputs to step B.3 include the annotated current experience flow diagram from step A.4 including modifications made in step A.8, and the solution selection matrix and annotated customer benefit roadmap from step B.2.

In step B.3.1 of the present embodiment, the components of the future customer experience flow are identified. First, the current experience flow diagram is reviewed to identify those gaps associated with the selected solution path. For the first milestone on the solution selection matrix, a list of the customer experience components that articulate the future experience relative to the selected solution is created, such that the set of components created for the first milestone describe the complete experience necessary to deliver the relevant value proposition. Next, for the second milestone, the additional components needed to deliver the benefits for the second milestone are created. This process is repeated for each remaining milestone.

In step B.3.2, in the present embodiment, using the components created in step B.3.1 for the first milestone, a flow diagram is created representing the order of the components and showing their sequential relationship. This flow diagram is intended to represent the future experience for the target customers that is a result of the customer experience improvement provided by the selected solution. A future experience job aid is provided to assist in this task.

For the other milestones, the remaining components created in step B.3.1 can be added to the future experience flow diagram, or a separate future experience flow diagram can be created for each milestone.

In step B.3.3, in the present embodiment, the solution ideas and other material generated in step B.2 are reviewed to identify any solution requirements. Additional solution requirements can be generated using a technique such as brainstorming. Any solution requirements can then be added to the future experience flow diagram, preferably near the component related to the requirement.

In step B.4 of FIG. 2B, scenario descriptions are created to build a further understanding of the selected solution and to communicate the future vision (the future customer experience with the selected solution path) to others. The scenarios can also be used to test the solution architecture that will be developed in later steps. Inputs to step B.4 include the customer and environmental profiles from step A.2, the customer requirements vignettes from step A.5, the customer benefit roadmap and solution selection matrix from step B.2, and the future experience flow diagram from step B.3.

In step B.4.1, in the present embodiment, the aforementioned inputs are reviewed to identify scenarios that are needed to communicate how the selected solution will provide the desired future experience. These scenarios can then be drafted. A solution scenario template is provided to assist with this task.

In step B.4.2 of the present embodiment, after the scenarios have been drafted, they are reviewed, finalized and distributed to help communicate the future experience vision to other people who need to buy in or become aware of the path forward.

In step B.5 of FIG. 2B, a high-level solution architecture is defined. An objective of this task is to define the primary elements and interdependencies of the solution architecture based on the future experience flow the architecture is expected to support. Here, the solution is related to a product or service rather than to the value delivery system. If the solution requires a change only to the value delivery system, step B.5 (and step B.6) can be skipped. Inputs to step B.5 include the customer benefits roadmap and solution path definition from step B.2, the future experience flow from step B.3, and the solution scenarios from step B.4.

In step B.5.1, in the present embodiment, the determination is made regarding whether a product or service solution architecture should be defined. If so, the process continues with step B.5.2. If not, the process skips to step B.7.

In step B.5.2, in the present embodiment, the future experience components are listed. A tools architecture template can be used to perform this task.

In step B.5.3, in the present embodiment, the types of elements appropriate to the solution architecture are first identified. The types of architecture elements can include: people/roles/organizations (e.g., key people, roles, departments or functional areas that are part of the solution); systems (e.g., major internal or external systems that are part of the solution); operations/processes (e.g., key operations and processes, particularly those that involve customers directly and those that cause a transformation of other elements of the solution); objects (e.g., hardware and other types of devices); and functions/capabilities (e.g., significant blocks of functionality such as storage, self-diagnostics, search, etc.). The architecture elements needed to support the first milestone are then identified and correlated with the components listed in step B.5.2; that is, for each future experience component, the elements needed to provide that aspect of the experience are identified. This process is repeated for each milestone.

In step B.5.4, in the present embodiment, a profile is created for each architecture element. For example, the following information can be recorded for each element: its name and version (if the responsibilities or capabilities of the element change across the customer benefit roadmap, then multiple versions of the element may be needed); the introduction milestone indicating at which milestone on the roadmap each version of the element is introduced; the element's responsibilities and capabilities; enablers (other elements that support the element); linkages with other elements; and any outstanding or unresolved issues that might affect the element. A template can be used to assist in the completion of this task.

In step B.5.5 of the present embodiment, a high-level solution architecture is constructed for the first milestone. The high-level solution architecture can be, for example, a diagram that includes each element and that shows the main linkages between the elements (e.g., data or information flows, material flows, financial flows, relationships, dependencies, etc.). After completion of a diagram for the first milestone, changes to the diagram for subsequent milestones are then made; if there are substantial changes to the high-level architecture from one milestone to the next, separate diagrams may be generated for each milestone.

In step B.5.6 of the present embodiment, a walkthrough is conducted to ensure that the customer requirements are understood and that the aspects of the design (e.g., the experience flows, scenarios, architectures, etc.) are accurately represented. A walkthrough job aid is provided to assist in performing this task. Any issues identified during the walkthrough can be recorded and addressed by refining the solution architecture, and the walkthrough can then be repeated for the modified architecture to ensure new problems have not been introduced by the modifications.

In step B.5.7, the solution architecture is reviewed by designers, developers and the like to ensure that it can be implemented.

In step B.6 of FIG. 2B, the high-level solution architecture is refined by defining the specific interaction requirements of the solution and specifying any additional architecture elements or linkages that may be needed. Step B.6 can be skipped if the high-level solution architecture of step B.5 is sufficiently detailed for specifying the solution design requirements. Inputs to step B.6 include the customer and environmental profiles from step A.2 and the high-level solution architecture of step B.5.

In step B6.1, in the present embodiment, the determination is made with regard to whether the high-level solution architecture is sufficiently detailed for specifying the solution design requirements; if so, the process moves to step B.7 and, if not, the process moves to step B.6.2.

In step B.6.2, in the present embodiment, use-cases are defined. A use-case defines the specific interactions the solution will need to support. First, the people (“actors”) who are likely to interact with the solution are identified, and the actors are then prioritized according to how important their interaction will be to the success of the solution. Next, the goals and tasks are identified for each actor. A job aid is provided to assist in the completion of this task.

Then, the use-cases are defined for each of the primary tasks. Here, the use-cases are defined assuming problem-free conditions. The use-cases are used to describe the task interactions between the actor and the solution in sufficient detail to identify the required architecture elements. For example, the interactions may be described as a sequence of numbered steps performed between the actor and the solution. The pertinent environmental conditions under which the interaction is expected to occur are also described. A use-case template is provided to assist with this task.

Next, use-cases are defined for problem conditions that the solution architecture will need to support. The use-cases defined above are reviewed and problems that could arise are identified. The problems are prioritized according to their likelihood of occurrence and their potential impact. A job aid can be used to assist with this task. A use-case is then created for each high priority problem condition that is identified.

In step B.6.3, in the present embodiment, walkthroughs of the interactions are conducted for each use-case. A walkthrough job aid is provided to assist in performing this task. Any issues identified during the walkthrough can be recorded and addressed by refining the solution architecture, and the walkthrough can then be repeated for the modified architecture to ensure new problems have not been introduced by the modifications.

In step B.7 of FIG. 2B, the solution value delivery system is defined to identify and correct any gaps in delivering the future experience flow and the solution architecture. Inputs to this task include the future experience flow from step B.3 and the solution architecture from step B.5 or step B.6.

In step B.7.1 of the present embodiment, the process requirements for the value delivery system (VDS) are defined using the customer experience components named in the future experience flow along with any solution requirements identified in step B.5 or B.6. The primary components of the future experience flow and the critical processes or functions required to deliver each component are listed. Then, for each of these, the process requirements are identified. A VDS functionality template is provided that can be used to perform this task.

In step B.7.2 of the present embodiment, the key components and critical processes are recorded onto a VDS map. A VDS template is provided to assist the user with this task.

In step B.7.3 of the present embodiment, for each process, the key partners (both internal and external) that are needed to deliver, develop or support the process are identified. The partner who is the “owner” of the process (the person or organization accountable for the outcome of the process) is identified. Partners having more of a supporting role are also so identified.

In step B.7.4, in the present embodiment, the partner commitments for the value delivery system are further investigated. That is, each partner is evaluated with regard to their expected motivation and level of commitment and whether they have the resources needed to be successful. A template is provided to help complete this task.

In step B.7.5, in the present embodiment, gaps or opportunities in the value delivery system are identified. Plans to address any issues so identified can then be developed.

In step B.8 of FIG. 2B, the solution is validated to identify any problems that may exist before proceeding further with the overall process. Inputs to this step include the solution path definition from step B.2, the future experience flow diagram(s) from step B.3, the scenario descriptions from step B.4, the high-level solution architecture from step B.5, the uses-cases from step B.6, and the value delivery system map from step B.7.

In step B.8.1, in the present embodiment, the inputs identified above, as well as the customer and environmental profiles, the competitive experience profile, the customer benefits roadmap, the value propositions, and the success criteria, are reviewed for use in validating the acceptability of the solution with the customer. The methodology that will be used for research and concept testing is selected according to the level of risk of the customer experience issue and solution; a job aid is provided to aid in this selection. Ongoing research and resources can also be investigated. Then, the research is conducted and customer information is updated to reflect what is learned. Any solution modifications that are needed based on the information from the validation are also recorded.

In step B.8.2, in the present embodiment, the feasibility of the solution is validated. In step B.8.3, any significant risks to the success of the solution are identified. Each risk so identified is rated according to its severity. A risk list template and a customer impact job aid are provided to assist in the completion of these tasks. For each area of potentially unacceptable risk, a proposed response is identified. In the case in which a risk is unacceptable, modifications may be made to the solution to reduce the risk.

Reference is now made to FIG. 2C, which describes step 130 in further detail. In the present embodiment, step 130 includes steps C.1 through C.3. An objective of steps C.1 through C.3 is to “close the loop” with the target customers to determine if the original customer experience issue or focus is resolved. This can be accomplished by soliciting customer feedback, to evaluate progress toward meeting the success criteria prior to release as well as to perform an ongoing evaluation against the post-release success criteria after the release of each solution milestone. Another objective of steps C.1 through C.3 is management of the solution implementation both before and during the customer evaluation process.

Step C.1 of FIG. 2C pertains to managing the solution implementation project. Although best practices are included in the TCE solution toolset, guidance for completing project management tasks is needed from other sources. Inputs to step C.1 include the customer benefits roadmap from step B.2, the future experience flow from step B.3, the solution architecture diagram from step B.6, and the VDS map and VDS partnership commitment matrix from step B.7.

In step C.1.1, in the present embodiment, the scope, resources and schedule for the project and the flexibility of each parameter is defined. A template is provided to assist in the completion of this task.

In step C.1.2, in the present embodiment, a schedule is established bearing in mind the milestones defined above, resource commitments are made, and a communication plan is developed. A template is also provided for these tasks.

In step C.2 of FIG. 2C, a plan is established to measure the solution against the pre-release success criteria, and to iterate the solution as needed to satisfy the metrics. Inputs to this task include the success criteria planning table from step A.7.

In step C.2.1, in the present embodiment, the measurement schedule is established. An owner can be assigned to each success criteria. Also, the test methodology chosen for the selected solution path is verified to be appropriate. A template is provided to assist in the completion of this task.

In step C.2.2, in the present embodiment, the solution is measured and the results are tracked against the goals that were set. In step C.2.3, the solution is iterated as needed if the measurements indicate that changes are needed to satisfy the metrics. The modified solution is then measured and further iterations to the solution can be made until the goals are achieved.

In step C.3 of FIG. 2C, customer feedback is used to improve the solution. Inputs to this step include the original customer issue or focus, customer experience baseline measurements, the success criteria planning table from step A.7, and the success criteria tracking table from step C.2.

In step C.3.1, in the present embodiment, the effectiveness of the selected solution is measured against the post-release success criteria. As measurements are taken, they are recorded and any trends are analyzed to evaluate the impact of the solution on the customer experience issue.

In step C.3.2, the measurement results are used to identify progress relative to the goals, to revise goals if they appear to be unrealistic, and to identify improvements to the solution to make it more effective. In step C.3.3, ongoing measurements are performed and the tasks of step C.3.2 are repeated. In step C.3.4, the affect of the solution on the total customer experience issue is documented and investigated along with similar information for other solutions addressing other customer experience issues to determine the overall success in resolving the original TCE issue.

The present invention thus provides a method that can be used by teams, even inexperienced ones, to identify solutions to customer experience issues. The present invention provides an approach that systematically leads the user to identify and develop an appropriate solution to a customer experience issue.

The preferred embodiment of the present invention, total customer experience solution toolset, is thus described. While the present invention has been described in particular embodiments, it should be appreciated that the present invention should not be construed as limited by such embodiments, but rather construed according to the following claims.

What is claimed is:

1. A method for developing a solution to a customer experience issue, said method comprising:
a) identifying a target customer including customer requirements and a customer profile;
b) defining a current customer experience and comparing it with a customer experience provided by a competitor;
c) summarizing values and benefits that should be provided to said target customer;
d) identifying metrics for measuring success of a solution;
e) identifying gaps between current solutions and said benefits; and
f) generating solutions for delivering said benefits and selecting a solution path which delivers the greatest number of benefits.

2. The method as recited in claim 1 further comprising:
defining a future customer experience for said solution path.

3. The method as recited in claim 2 further comprising:
identifying milestones for delivering said values and benefits;
identifying components of said future customer experience for each milestone;
generating a future customer experience flow by organizing future customer experience components for each milestone according to their order of occurrence; and
aligning said solution path with said milestones.

4. The method as recited in claim 2 further comprising:
developing an architecture for implementing said solution path.

5. The method as recited in claim 4 wherein developing said architecture comprises:
identifying milestones for delivering said values and benefits;
identifying components of said future customer experience for each milestone;
identifying elements of said architecture needed for each milestone; and
assembling said elements to construct said architecture.

6. The method as recited in claim 5 further comprising:
identifying participants in said solution path;
creating and prioritizing goals for said participants;
identifying tasks for accomplishing goals selected according to their priority;
defining use-cases describing task interactions between said participants and said solution path; and
identifying and addressing problems with said solution path using said use-cases.

7. The method as recited in claim 5 further comprising:
defining a value delivery system identifying elements and participants associated with delivering said solution path to said target customer.

8. The method as recited in claim 7 wherein defining said value delivery system comprises:
identifying components of said future customer experience;
identifying requirements for delivering each component of said future customer experience; and
identifying participants who are associated with said components and delivery requirements.

9. The method as recited in claim 8 further comprising:
identifying gaps in said value delivery system; and
identifying solutions addressing gaps in said value delivery system.

10. The method as recited in claim 2 further comprising:
defining scope, resources and schedule for implementing said solution path.

11. The method as recited in claim 2 further comprising:
developing a schedule for measuring performance of said solution path against said metrics.

12. The method as recited in claim 11 further comprising:
measuring performance of said solution path; and
identifying and implementing changes to said solution path to improve said performance.

13. The method as recited in claim 1 wherein said step a) comprises:
collecting data about customers affected by said customer experience issue;
segmenting customers and identifying a customer segment most affected by said customer experience issue, said customer segment representing said target customer; and
identifying attributes of said target customer associated with said customer experience issue to generate said customer profile.

14. The method as recited in claim 13 further comprising:
generating an environmental profile of said target customer, said environmental profile comprising attributes of an environment associated with said target customer.

15. The method as recited in claim 1 wherein said step b) comprises:
generating a customer experience flow by organizing components of said current customer experience according to their order of occurrence, wherein said customer experience flow is referenced to said customer requirements and identifies instances in which said customer requirements are unmet;
identifying gaps between attributes of said current customer experience and attributes of said customer experience provided by said competitor; and
updating said customer experience flow to include said gaps between said attributes.

16. The method as recited in claim 1 wherein said step c) comprises:
identifying said benefits;
categorizing said benefits according to their value to said target customer;
prioritizing said benefits according to their relative importance;
selecting a subset of benefits according to their value;
identifying milestones for delivering said values and benefits; and
creating value propositions for each milestone, wherein a value proposition comprises a summary of value provided at each milestone.

17. The method as recited in claim 16 further comprising:
aligning said solution path with said milestones.

18. The method as recited in claim 1 wherein said metrics comprise pre-release metrics and post-release metrics, wherein pre-release metrics are for measuring success during development of said solution path and wherein post-release metrics are for measuring success after implementation of said solution path.

19. The method as recited in claim 1 wherein said step d) comprises:
defining units of measure for said metrics;
identifying measurement methods;
defining criteria which indicate acceptable values for said metrics; and
establishing baseline values for said metrics.

20. A method for developing a solution to a customer experience issue, said method comprising:
a) collecting data about customers affected by said customer experience issue;
b) segmenting customers and identifying a customer segment most affected by said customer experience issue, said customer segment representing a target customer;
c) identifying attributes of said target customer associated with said customer experience issue to generate a customer profile;
d) generating a customer experience flow by organizing components of a current customer experience according to their order of occurrence, wherein said customer experience flow identifies instances in which customer requirements are unmet;
e) identifying gaps between attributes of said current customer experience and attributes of a customer experience provided by a competitor;
f) summarizing values and benefits that should be provided to said target customer; and
g) identifying metrics for measuring success of a solution.

21. The method as recited in claim 20 further comprising:
defining a future customer experience for a selected solution.

22. The method as recited in claim 20 further comprising:
updating said customer experience flow to include said gaps between said attributes.

23. The method as recited in claim 20 wherein said step f) comprises:
identifying said benefits;
categorizing said benefits according to their value to said target customer;
prioritizing said benefits according to their relative importance;
selecting a subset of benefits according to their value;
identifying milestones for delivering said values and benefits;
creating value propositions for each milestone, wherein a value proposition comprises a summary of value provided at each milestone; and
aligning selected solutions with said milestones.

24. The method as recited in claim 20 further comprising:
generating an environmental profile of said target customer, said environmental profile comprising attributes of an environment associated with said target customer.

25. The method as recited in claim 20 wherein said metrics comprise pre-release metrics and post-release metrics, wherein pre-release metrics are for measuring success during development of said solution and wherein post-release metrics are for measuring success after implementation of said solution.

26. The method as recited in claim 20 wherein said step g) comprises:
defining units of measure for said metrics;
identifying measurement methods;
defining criteria which indicate acceptable values for said metrics; and
establishing baseline values for said metrics.

27. A method for developing a solution to a customer experience issue, said method comprising:
a) identifying gaps between current solutions and benefits that should be provided to a target customer;
b) generating solutions for delivering said benefits and selecting a solution path which delivers the greatest number of benefits;
c) defining a future customer experience for a selected solution;
d) developing an architecture for implementing said solution path; and
e) defining use-cases describing task interactions between participants in said solution path and said solution path.

28. The method as recited in claim 27 further comprising:
defining a value delivery system identifying elements and participants associated with delivering said solution path to said target customer.

29. The method as recited in claim 28 wherein defining said value delivery system comprises:
identifying components of said future customer experience;
identifying requirements for delivering each component of said future customer experience; and
identifying participants who are associated with said components and delivery requirements.

30. The method as recited in claim 29 further comprising:
identifying gaps in said value delivery system; and
identifying solutions addressing gaps in said value delivery system.

31. The method as recited in claim 27 wherein said step c) further comprises:
identifying milestones for delivering said benefits;
identifying components of said future customer experience for each milestone;
generating a future customer experience flow by organizing future customer experience components for each milestone according to their order of occurrence; and
aligning said solution path with said milestones.

32. The method as recited in claim 27 wherein said step d) comprises:
identifying milestones for delivering said benefits;
identifying components of said future customer experience for each milestone;
identifying elements of said architecture needed for each milestone; and
assembling said elements to construct said architecture.

33. The method as recited in claim 27 wherein said step e) comprises:
identifying said participants in said solution path;
creating and prioritizing goals for said participants;
identifying tasks for accomplishing goals selected according to their priority; and
identifying and addressing problems with said solution path using said use-cases.
